(19) United States
(12) Patent Application Publication
(10) Pub. No.: US 2020/0022468 A1
(43) Pub. Date: Jan. 23, 2020

(54) ZIPPER LOCK

(71) Applicant: Sinox Lock (Kunshan) Co., Ltd., Kunshan City (CN)

(72) Inventor: TAO SONG, Kunshan City (CN)

(21) Appl. No.: 16/513,717

(22) Filed: Jul. 17, 2019

(30) Foreign Application Priority Data
Jul. 20, 2018 (CN) 201821160855.0

(51) Int. Cl. A44B 19/30; E05B 65/52

(52) U.S. Cl. CPC A44B 19/301; E05B 37/0034; E05B 65/52

(57) ABSTRACT

A zipper lock contains: a first zipper slider, a second zipper slider, a locking device, a first locking element, and at least one lock mechanism. The locking device includes a first lock body and a second lock body detachable from the first lock body. The first lock body is connected with the first zipper slider, and the second lock body is connected with the second zipper slider. The locking element is arranged on the first lock body and is configured to lock with the second lock body. At least one lock mechanism is arranged on the first lock body or the second lock body to lock with the locking element.

### FIELD OF THE INVENTION

The present invention relates to a zipper lock which is connected with at least one zipper slider configured to lock with an object (such as a luggage).

### BACKGROUND OF THE INVENTION

A conventional zipper lock is fixed on specific location of the luggage, hence to lock the luggage the zippers on the luggage need to be move to the conventional zipper lock.

The present invention has arisen to mitigate and/or obviate the afore-described disadvantages.

### SUMMARY OF THE INVENTION

The primary aspect of the present invention is to provide a zipper lock which replaces the conventional zipper by using the first lock body and the second lock body, and the first lock body is locked with the second lock body, thus locking the first zipper slider with the second zipper slider securely.

To obtain above-mentioned aspect, a zipper lock provided by the present invention contains: a first zipper slider, a second zipper slider, a locking device, a first locking element, and at least one lock mechanism.

The locking device includes a first lock body and a second lock body detachable from the first lock body, wherein the first lock body is connected with the first zipper slider, and the second lock body is connected with the second zipper slider.

The locking element is arranged on the first lock body and is configured to lock with the second lock body; and

At least one lock mechanism is arranged on the first lock body or the second lock body so as to lock with the locking element.

Preferably, the first lock body has a first connection face and one of at least one magnet arranged on the first connection face, and the second lock body has a second connection face and at least one magnet arranged on the second connection face.

Preferably, the second lock body has a release button configured to release the locking element.

Preferably, the at least one lock mechanism is a key lock mechanism or a combination lock mechanism.

### BRIEF DESCRIPTION OF THE DRAWINGS

FIG. 1 is a perspective view showing the assembly of a zipper lock according to a first embodiment of the present invention.

FIG. 2 is a perspective view showing the exploded components of a part of the zipper lock according to the first embodiment of the present invention.

FIG. 3 is another perspective view showing the exploded components of a part of the zipper lock according to the first embodiment of the present invention.

FIG. 4 is a side plan view showing the exploded components of the zipper lock according to the first embodiment of the present invention.

FIG. 5 is a cross sectional view showing the assembly of the zipper lock according to the first embodiment of the present invention.

FIG. 6 is a cross sectional view showing the operation of the zipper lock according to the first embodiment of the present invention.

FIG. 7 is another cross-sectional view showing the operation of the zipper lock according to the first embodiment of the present invention.

FIG. 8 is a perspective view showing the assembly of a zipper lock according to a second embodiment of the present invention.

FIG. 9 is a perspective view showing the assembly of the zipper lock according to the second embodiment of the present invention.

FIG. 10 is a perspective view showing the exploded components of a part of the zipper lock according to the second embodiment of the present invention.

FIG. 11 is a side plan view showing the operation of the zipper lock according to the second embodiment of the present invention.

FIG. 12 is a cross sectional view showing the assembly of the zipper lock according to the second embodiment of the present invention.

FIG. 13 is a perspective view showing the operation of the zipper lock according to the second embodiment of the present invention.

FIG. 14 is another perspective view showing the operation of the zipper lock according to the second embodiment of the present invention.

### DETAILED DESCRIPTION OF THE PREFERRED EMBODIMENTS

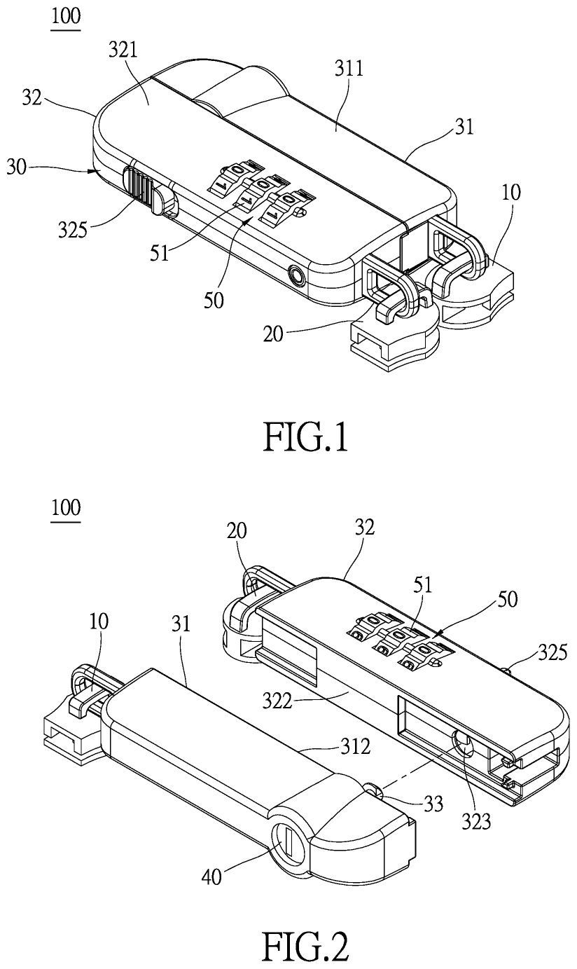

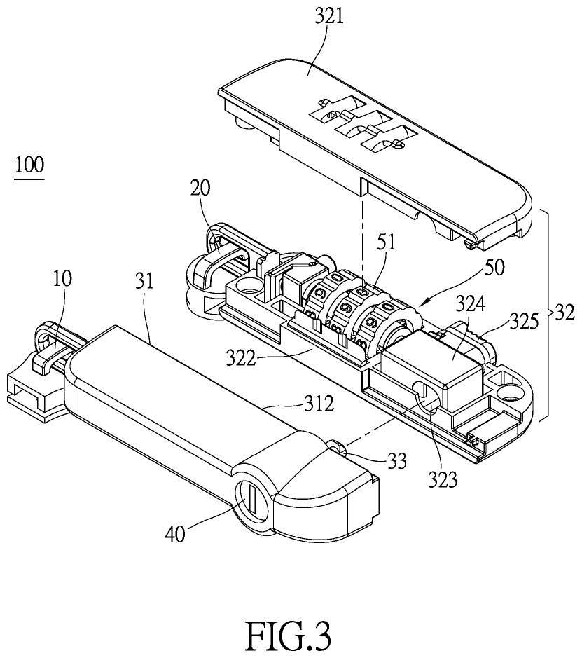

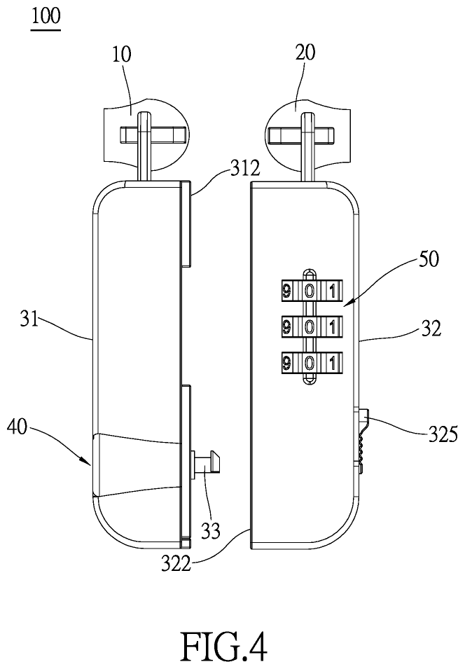

With reference to FIGS. 1-4, a zipper lock 100 according to a first embodiment of the present invention is connected with at least one zipper slider configured to lock with an object (such as a luggage), and the zipper lock 100 comprises: a first zipper slider 10, a second zipper slider 20, and a locking device 30.

The locking device 30 includes a first lock body 31 and a second lock body 32 detachable from the first lock body 31, wherein the first lock body 31 is connected with the first zipper slider 10, the second lock body 32 is connected with the second zipper slider 20. The first lock body 31 has a first lock housing 311 and a first connection face 312 formed on the first lock housing 311, and the second lock body 32 has a second lock housing 321 and a second connection face 322 formed on the second lock housing 321, such that the first lock body 31 and the second lock body 32 are connected by the first connection face 312 and the second connection face 322 respectively.

The first lock body 31 has a locking element 33 configured to lock with the second lock body 32, and the first lock body 31 has a first lock mechanism 40 arranged on the first lock housing 311.

The second lock body 32 has a receiving orifice 323 configured to accommodate the locking element 33. the second lock housing 321 has a latch 324 configured to lock with the locking element 33, and the second lock housing 321 has a release button 325 configured to release the locking element 33.

The zipper lock 100 comprises a pair of zipper sliders, i.e., the first zipper slider 10 and a second zipper slider 20, wherein the first zipper slider 10 has the first lock body 31 connected thereon, the second zipper slider 20 has the second lock body 32 connected thereon, and the first zipper slider 10 is locked with the second zipper slider 20.

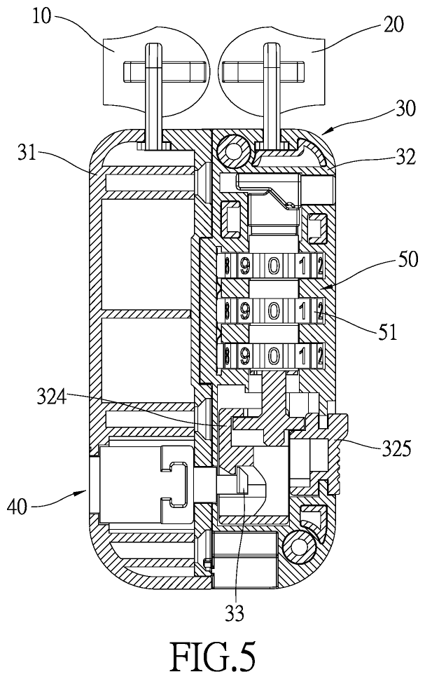

Referring to FIG. 5, the first lock body 31 is connected and locked with the second lock body 32 by using the locking element 33.

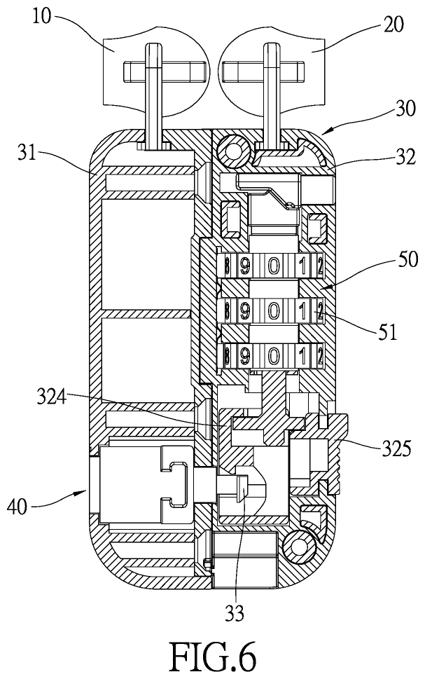

The first lock body 31 is detached from the second lock body 32 by first lock mechanism 40 or a second lock mechanism 50. In this embodiment, the first lock mechanism 40 of the first lock body 31 is a key lock mechanism operated by a key so as to actuate the locking element 33 to rotate (as shown in FIG. 6), and the locking element 33 is pulled out of the receiving orifice 323 of the second lock body 32, thus detaching the first lock body 31 from the second lock body 32.

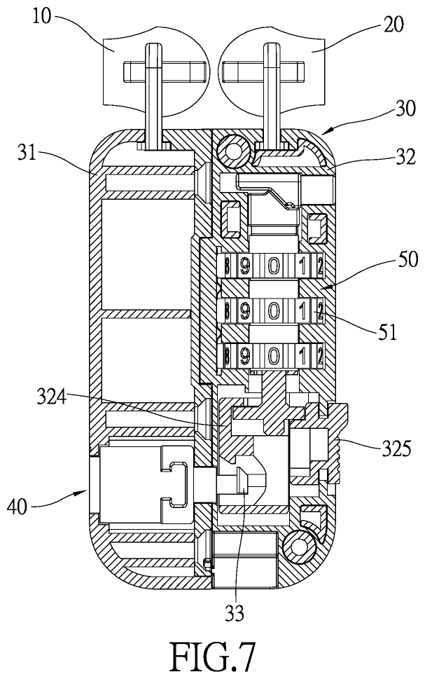

Furthermore, the first lock body 31 is detached from the second lock body 32 by the second lock mechanism 50. In this embodiment, the second lock mechanism 50 of the first lock body 32 is a combination lock mechanism. For example, a code wheel 51 of the combination lock mechanism is rotated to set passwords so that the release button 325 actuates the latch 324 to move (as illustrated in FIG. 7), and the locking element 33 is pulled out of the receiving orifice 323 of the second lock body 32, thus detaching the first lock body 31 from the second lock body 32.

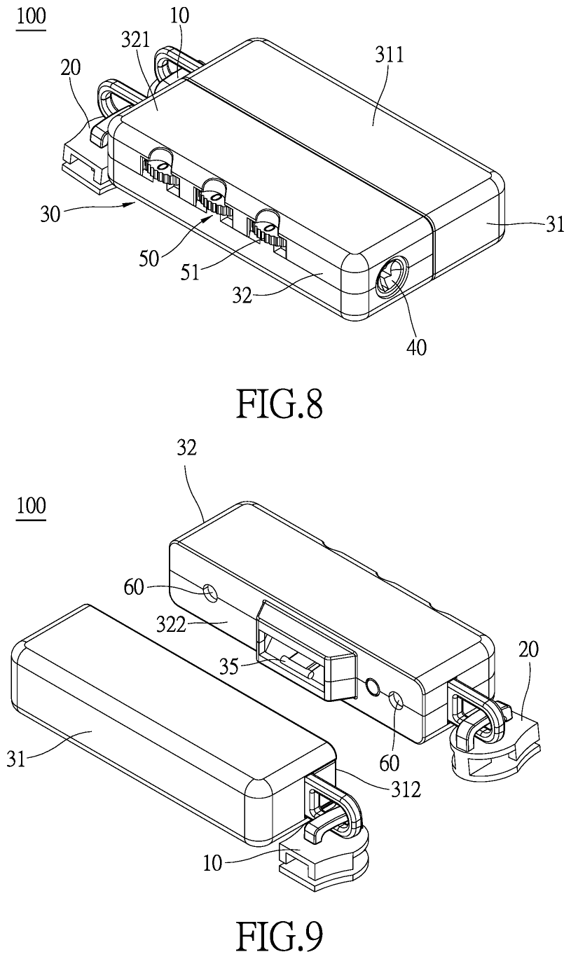

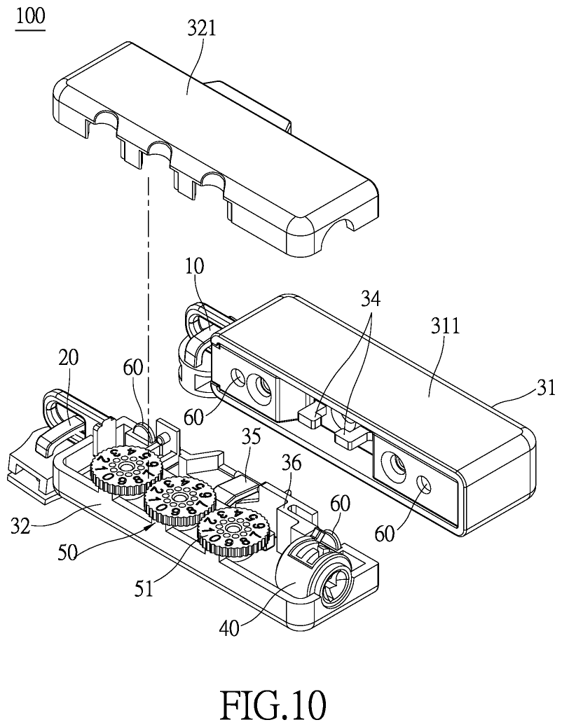

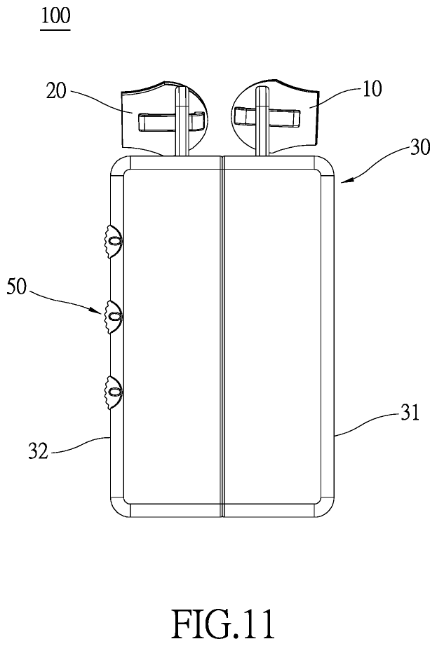

With reference to FIGS. 8-11, in a second embodiment, a zipper lock 100 comprises a first zipper slider 10, a second zipper slider 20, and a locking device 30.

The locking device 30 includes a first lock body 31 and a second lock body 32 detachable from the first lock body 31, wherein the first lock body 31 is connected with the first zipper slider 10, the second lock body 32 is connected with the second zipper slider 20. The first lock body 31 has a first lock housing 311 and a first connection face 312 formed on the first lock housing 311, and the second lock body 32 has a second lock housing 321 and a second connection face 322 formed on the second lock housing 321, such that the first lock body 31 and the second lock body 32 are connected by the first connection face 312 and the second connection face 322 respectively. In this embodiment, the first lock body 31 has at least one magnet 60 arranged on the first connection face 312 of the first lock body 31, and the second lock body 32 has at least one magnet 60 arranged on the second connection face 322 of the second lock body 32 and magnetically attracting with the magnet 60 of the first connection face 312 of the first lock body 31.

The first lock body 31 has a retainer 34.

The second body 32 has a movable protrusion 35 hooked with the retainer 34, and the second locking housing 321 has a first lock mechanism 40 and a second lock mechanism 50.

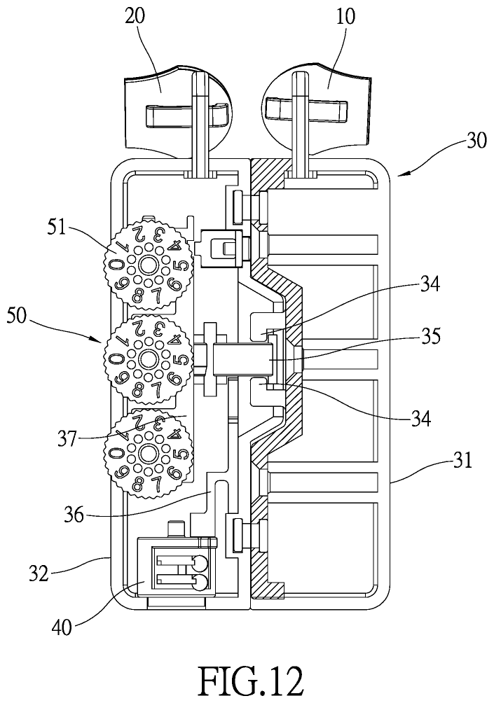

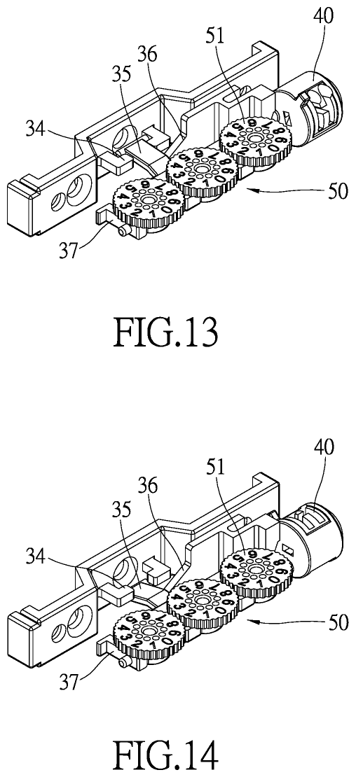

Referring to FIGS. 12 and 13, the first lock body 31 is connected and locked with the second lock body 32 by hooking the movable protrusion 35 with the retainer 34.

The first lock body 31 is detached from the second lock body 32 by using the first lock mechanism 40 or the second lock mechanism 50. In this embodiment, the first lock mechanism 40 of the second lock body 32 is a key lock mechanism which is operated by a key, such that a column 36 of the second lock body 32 directly or indirectly actuates the movable protrusion 35 to move toward an unhooking position of the retainer 34 (as illustrated in FIG. 14), thus detaching the first lock body 31 from the second lock body 32.

The first lock body 31 is detachable from the second lock body 32 by using the second lock mechanism 50. The second lock mechanism 50 of the second lock body 32 is a combination lock mechanism. For example, a code wheel 51 of the combination lock mechanism is rotated to set passwords so that an actuation plate 37 of the second body 32 directly or indirectly actuates the movable protrusion 35 toward an unhooking position of the retainer 34 (as illustrated in FIG. 14), thus detaching the first lock body 31 from the second lock body 32.

Accordingly, the zipper lock 100 replaces the conventional zipper by using the first lock body 31 and the second lock body 32, and the first lock body 31 is locked with the second lock body 32, thus locking the first zipper slider 10 with the second zipper slider 20 securely.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A zipper lock comprising:
a first zipper slider;
a second zipper slider;
a locking device including a first lock body and a second lock body detachable from the first lock body, wherein the first lock body is connected with the first zipper slider, and the second lock body is connected with the second zipper slider;
a locking element arranged on the first lock body and configured to lock with the second lock body; and
at least one lock mechanism arranged on the first lock body or the second lock body to lock with the locking element.

2. The zipper lock as claimed in claim 1, wherein the first lock body has a first connection face and at least one magnet arranged on the first connection face, and the second lock body has a second connection face and at least one magnet arranged on the second connection face.

3. The zipper lock as claimed in claim 1, wherein the second lock housing has a release button configured to release the locking element.

4. The zipper lock as claimed in claim 1, wherein at least one lock mechanism is a key lock mechanism or a combination lock mechanism.

5. The zipper lock as claimed in claim 1, wherein the locking device includes multiple lock mechanisms.

6. The zipper lock as claimed in claim 5, wherein the multiple lock mechanisms are a first lock mechanism arranged on the first lock body, and the multiple lock mechanisms are a second lock mechanism arranged on the second lock body.

7. The zipper lock as claimed in claim 5, wherein the multiple lock mechanisms are a first lock mechanism and a second lock mechanism which are arranged on the second lock body.
